(19) United States
(12) Patent Application Publication
(10) Pub. No.: US 2025/0348791 A1
(43) Pub. Date: Nov. 13, 2025

(54) NON-TRANSITORY COMPUTER-READABLE RECORDING MEDIUM, INFORMATION PROCESSING APPARATUS, AND REINFORCEMENT LEARNING METHOD

(71) Applicant: Fujitsu Limited, Kawasaki-shi, (JP)

(72) Inventors: Hayato DAN, Yokohama (JP); Natsuki ISHIKAWA, Yamato (JP); Yoshihiro OKAWA, Yokohama (JP); Masatoshi OGAWA, Zama (JP)

(73) Assignee: Fujitsu Limited, Kawasaki-shi, (JP)

(21) Appl. No.: 19/276,053

(22) Filed: Jul. 22, 2025

Related U.S. Application Data
(63) Continuation of application No. PCT/JP2023/045083, filed on Dec. 15, 2023.

(30) Foreign Application Priority Data
Feb. 20, 2023 (JP) 2023-024535

(51) Int. Cl. G06N 20/00; G06F 17/11

(52) U.S. Cl. CPC G06N 20/00; G06F 17/11

(57) ABSTRACT

A non-transitory computer-readable recording medium has stored therein a program that causes a computer to execute processing including, in a policy optimization problem in reinforcement learning when a trust region is set and policy update is performed, observing a difference between policies before and after update, and adjusting a threshold of the trust region according to an operation of an algorithm performing policy update such that the observed difference remains within a certain range of the trust region.

### CROSS-REFERENCE TO RELATED APPLICATION

This application is a continuation of International Application No. PCT/JP2023/045083, filed on Dec. 15, 2023 which claims the benefit of priority of the prior Japanese Patent Application No. 2023-024535, filed on Feb. 20, 2023, the entire contents of which are incorporated herein by reference.

### FIELD

The embodiments discussed herein are related to a computer-readable recording medium and the like.

### BACKGROUND

Conventionally, there is a technology of reinforcement learning in which an action is determined on the basis of the policy for a certain environment and the policy is updated on the basis of a reward obtained as a result to update (improve) the policy so that the reward is optimized.

As a method of updating a policy, for example, trust region policy optimization (TRPO) is known. Such TRPO regards policy update in the reinforcement learning as a constrained optimization problem of a KL (Kullback-Leibler) divergence between the policies before and after the update as in the following Expression (1). Note that π_{old} and π_{new} are policies (probability distributions) before and after the update. J(⋅) is an expected value of reward. E[D_{KL}(π_{new}∥π_{old})] is an expected value of the KL divergence between the policies before and after the update.

$${π}_{new} = {arg max}_{π} J ( π ) - J ( {π}_{old} ) \qquad ( 1 )$$

$$subject to E [ {D}_{K L} ( π ‖ {π}_{o l d} ) ] \leq δ$$

The KL divergence represented by D_{KL}(π_{new}∥π_{old}) is an index representing a difference between two probability distributions. The TRPO can therefore be said to be an algorithm in which an upper limit δ is set for a difference between the policies before and after the update and then the policy π_{new} is obtained having a maximum improvement range of the reward expected value. Note that, since it is actually difficult to strictly obtain the expected of reward value J(⋅) and the expected value of the KL divergence E[D_{KL}(π_{new}∥π_{old})], the expected value of reward and the expected value of the KL divergence are obtained by use of an approximate value of the policy using data collected in the policy before the update. At this time, if the policies before and after the update are greatly different from each other, approximation is not usable, and thus the upper limit δ is set for the KL divergence as a trustable region.

In addition, there is a constrained policy optimization (CPO) as a derived algorithm of the TRPO. The CPO is an algorithm used when a physical constraint or the like is considered for a policy. Similarly to the TRPO, the CPO also performs policy update in consideration of the optimization problem in which the upper limit is set for the KL divergence.

Furthermore, a technology related to improving a policy in reinforcement learning is disclosed (see, for example, Patent Literatures 1 and 2).
Patent Literature 1: Japanese Laid-open Patent Publication No. 2021-064222
Patent Literature 1: Japanese Laid-open Patent Publication No. 2021-033332

By the way, in reinforcement learning in which an upper limit is set for the KL divergence as in the trust region policy optimization (TRPO), it is known that progress of training changes depending on a value of the upper limit of the KL divergence δ. However, since training takes a lot of time, it is inefficient to perform training with various upper limit δ values and find an optimal value among the various upper limit δ values. That is, there is a problem that it is difficult to automatically adjust the value of the upper limit δ optimal for training.

### SUMMARY

According to an aspect of an embodiment, a non-transitory computer-readable recording medium has stored therein a program that causes a computer to execute processing including, in a policy optimization problem in reinforcement learning, observing a difference between policies before and after update when a trust region is set and policy update is performed, and adjusting a threshold of the trust region according to an operation of an algorithm leading to policy update to cause the observed difference to remain within a certain range of the trust region.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a functional configuration of an information processing apparatus according to a first embodiment;

FIG. 2 is a diagram describing policy update performed in training according to the first embodiment;

FIG. 3 is a diagram describing adjustment of δ according to the first embodiment;

FIG. 4 is a diagram illustrating an example of a flowchart of reinforcement learning processing according to the first embodiment;

FIG. 5 is a diagram illustrating an example of a flowchart of adjustment processing according to the first embodiment;

FIG. 6 is a diagram illustrating an example of a flowchart of adjustment processing according to a second embodiment;

FIG. 7 is a diagram illustrating an example of a flowchart of adjustment processing according to a third embodiment;

FIG. 8 is a diagram illustrating an example of results of verification of the reinforcement learning processing according to the first to third embodiments;

FIG. 9 is a diagram illustrating an example of a computer that executes a computer-readable recording medium; and

FIG. 10 illustrates graphs illustrating progress of training with the changed upper limits 8.

### DESCRIPTION OF EMBODIMENTS

Preferred embodiments of the present invention will be explained with reference to accompanying drawings. Note that the present invention is not limited to the embodiments.

First, reinforcement learning will be described. In the reinforcement learning, an action is determined for a certain environment on the basis of a policy, and the policy is updated on the basis of a reward obtained as a result of the determination, whereby the policy is updated so that the reward is optimized. That is, in the reinforcement learning, training is performed to update the policy to better one on the basis of a history of actions, rewards, and the like.

The reinforcement learning includes a trust region policy optimization (TRPO) method. In the TRPO method, policy update in the reinforcement learning is regarded as a constrained optimization problem of a KL divergence between policies before and after update. The TRPO is an algorithm using Expression (1) described above. That is, the TRPO is an algorithm in which an upper limit value (δ in Expression (1)) is set for a difference between the policies before and after the update and then a policy is obtained having a maximum improvement range of an expected value of reward (J(⋅) in Expression (1)).

Actually, since it is difficult to strictly obtain the expected value of reward (J(⋅) in Expression (1)) and an expected value of the KL divergence (E[D_{KL}(π_{new}∥π_{old})] in Expression (1)), in the TRPO, the expected value of reward and the expected value of the KL divergence are obtained by use of an approximate value of the policy using data collected in the policy before the update. At this time, if the policies before and after the update are greatly different from each other, approximation is not usable, and thus the upper limit δ is set for the KL divergence as a trustable region.

Here, in the reinforcement learning in which an upper limit is set for the KL divergence as in the TRPO, it is known that progress of training changes depending on a value of the upper limit δ of the KL divergence.

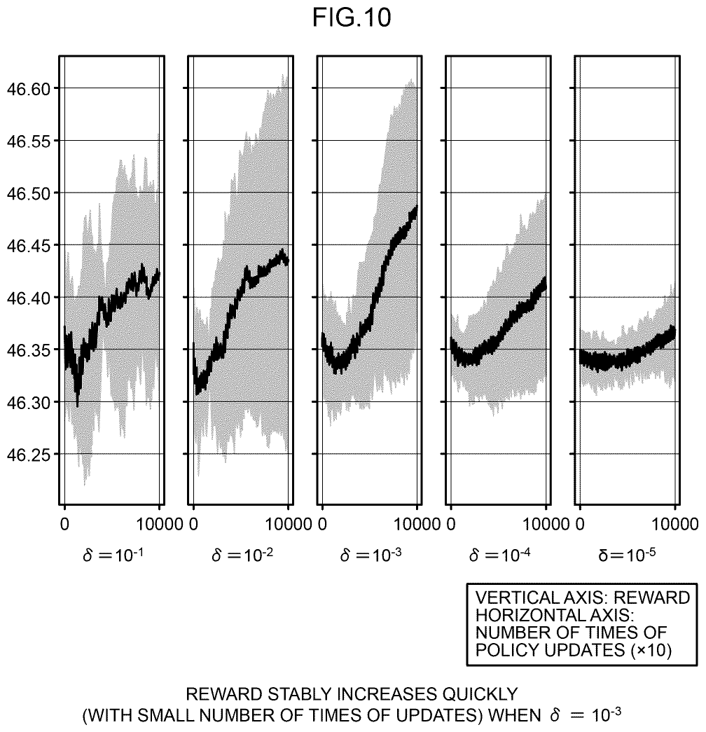

FIG. 10 illustrates graphs illustrating progress of training with the changed upper limits 8. Each graph is a training result in a case where the value of the upper limit δ is “10⁻¹”, “10⁻²”, “10⁻³”, “10⁻⁴”, or “10⁻⁵”. In each graph, the horizontal axis represents the number of times of policy update, and the vertical axis represents the reward. Each graph is a result of performing the same training three times, and represents an average and a variance. The black solid line is the average.

According to this, the reward stably increases quickly (with a small number of times of policy update) in a case where the upper limit δ is “10⁻³”. In a case where the upper limit δ is “10⁻¹”, although the reward increases, it is unstable. In a case where the upper limit δ is “10⁻²”, although the reward increases, the variance (variation) is large. Furthermore, in a case where the upper limit δ is “10⁻⁴” or “10⁻⁵”, although the reward gradually increases, training speed is slow. As described above, it is suggested that the upper limit δ has an optimal value for policy optimization training. In addition, the upper limit δ is expected to be different for each subject problem.

Generally, since training takes a lot of time, it is inefficient to perform training with various upper limit δ values and find an optimal value of the upper limit δ. That is, it is difficult to automatically adjust the value of the upper limit δ optimal for training.

Thus, in the following embodiments, a description will be given of a method of searching for an optimal upper limit value by dynamically adjusting the upper limit value δ of the difference between the policies before and after the update in parallel with the policy optimization training.

### (a) First Embodiment

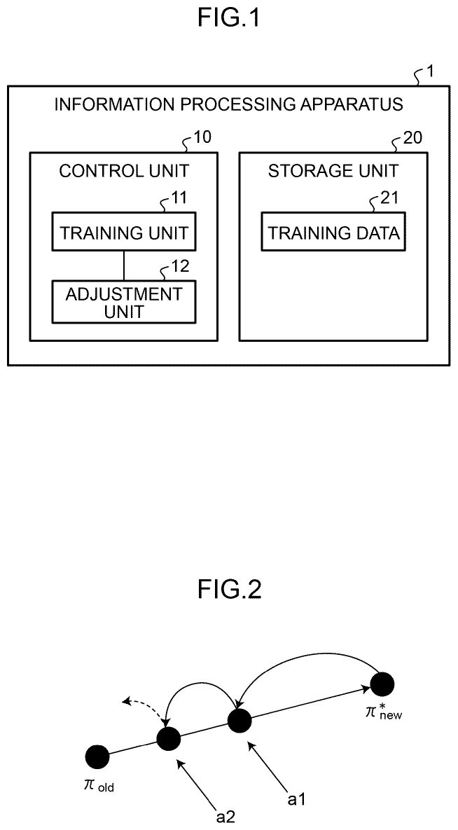

FIG. 1 is a block diagram illustrating an example of a functional configuration of an information processing apparatus according to a first embodiment. In reinforcement learning, an information processing apparatus 1 illustrated in FIG. 1 observes a difference between policies before and after update when setting a trust region and performing policy update, and adjusts a threshold (upper limit value δ) of the trust region to cause the observed difference to remain within a certain range of the trust region. That is, the information processing apparatus 1 dynamically adjusts the upper limit value δ of the difference between the policies before and after the update in parallel with policy optimization training.

The information processing apparatus 1 includes a control unit 10 and a storage unit 20. The control unit 10 includes a training unit 11 and an adjustment unit 12. The storage unit 20 includes training data 21. Note that the training unit 11 is an example of an observation unit. The adjustment unit 12 is an example of an adjustment unit.

The training data 21 stores data used for training. The training data 21 is log data in which an action performed on the basis of a policy, a state of an environment when the action is performed, and an obtained reward are stored for each of policies. The training data 21 may be referred to as Trajectory.

The training unit 11 sets the trust region and performs policy update. For example, the training unit 11 collects Trajectory from the training data 21 on the basis of a current policy. Then, the training unit 11 updates the policy so that the optimization problem of Expression (1) is satisfied using the collected Trajectory. That is, the training unit 11 sets a constraint condition to cause a difference D_{KL}(π∥π_{old}) (KL divergence) between the policies before and after the update to be less than or equal to the upper limit δ on the basis of Expression (1), and then obtains the policy π_{new} having a maximum improvement range of an expected value of reward J(⋅), and perform policy update. Note that the constraint condition (see the right expression of Expression (1)) is an example of the trust region. The upper limit value δ of the constraint condition is an example of the threshold of the trust region.

In an actual algorithm, it is difficult to obtain a strict solution of the policy π of the optimization problem of Expression (1). For this reason, the training unit 11 performs the following processing using a solution π⁺_{new} of the approximate optimization problem, which can be solved. The training unit 11 determines whether the solution π⁺_{new} satisfies the constraint condition of the optimization problem in relation to the solution π_{old} before the update. That is, the training unit 11 determines whether the constraint condition is satisfied that a difference between the approximate solution π⁺_{new} and the solution π_{old} before the update is less than or equal to δ. Then, in a case where the approximate solution π⁺_{new} does not satisfy the constraint condition of the optimization problem in relation to the solution π_{old} before the update, the training unit 11 changes the approximate solution π⁺_{new} closer to the solution π_{old} before the update and performs determination processing again. Then, if the approximate solution π⁺_{new} satisfies the constraint condition of the optimization problem in relation to the solution π_{old} before the update, the training unit 11 updates the policy to the approximate solution π⁺_{new}. That is, the training unit 11 repeats the determination processing to ensure that the constraint condition of the optimization problem of Expression (1) is satisfied. Note that the number of times of repetition changes depending on the value of δ. Processing of searching for an approximate solution that satisfies the constraint condition in a line between the solution π_{old} before the update and the approximate solution π⁺_{new} in this manner is referred to as “line search”.

Here, the policy update performed in training in the training unit 11 will be described with reference to FIG. 2. FIG. 2 is a diagram describing the policy update performed in training according to a first embodiment. The π_{old} illustrated in FIG. 2 is a policy before the update. The π⁺_{new} illustrated in FIG. 2 is an approximate solution of π_{new} (for example, see the left expression of Expression (1)). Note that π⁺_{new} is an approximate solution having a maximum improvement range of the expected value of reward in relation to π_{old} according to the line search.

Under such a situation, the training unit 11 determines whether π⁺_{new} satisfies the constraint condition of the optimization problem in relation to π_{old} before the update (for example, see the right expression of the Expression (1)). In a case where the approximate solution π⁺_{new} does not satisfy the constraint condition of the optimization problem in relation to the solution π_{old} before the update, the training unit 11 executes line search. That is, the training unit 11 brings the approximate solution π⁺_{new} closer to the solution π_{old} before the update (reference sign a1), and performs the determination processing again as to whether a new π⁺_{new} satisfies the constraint condition of the optimization problem in relation to the solution π_{old} before the update (for example, see the right expression of the Expression (1)). Then, if the approximate solution π⁺_{new} satisfies the constraint condition, the training unit 11 updates the policy to the approximate solution π⁺_{new}. If the approximate solution π⁺_{new} does not satisfy the constraint condition, the training unit 11 repeats the line search until the approximate solution π⁺_{new} satisfies the constraint condition (reference sign a2). Note that, in a case where π⁺_{new} at the first time satisfies the constraint condition of the optimization problem in relation to π_{old} before the update, the training unit 11 updates the policy to the approximate solution π⁺_{new} at the first time without the line search.

Returning to FIG. 1, the adjustment unit 12 adjusts the threshold of the trust region on the basis of the policy update for one time. For example, the adjustment unit 12 adjusts the upper limit value δ of the constraint condition by focusing on a line search operation.

As an example, in a case where the policy is updated without the line search (in the determination processing at the first time), the adjustment unit 12 increases the upper limit value δ by a predetermined value set in advance. From the fact that the approximate solution π⁺_{new} can be updated without the line search, it can be said that the accuracy of approximation is sufficient, and thus, the upper limit value δ is increased for improvement of the training speed. Note that the predetermined value only needs to be defined in advance according to the magnitude of the upper limit value δ, for example.

In addition, in a case where the line search is started and the policy update has succeeded, the adjustment unit 12 decreases the upper limit value δ by a predetermined value. From the fact that the line search is started and the approximate solution π⁺_{new} is updated, it can be said that the accuracy of approximation is not sufficient, and thus, the upper limit value δ is decreased for improvement of the accuracy of approximation and accurate policy update.

Furthermore, in a case where the policy update has failed by the line search, the adjustment unit 12 increases the upper limit value δ by a predetermined value. It can be said that π⁺_{new} returns to π_{old} before the update and no good policy has been found as a result of repeating the line search, and thus the upper limit value δ is increased to expand the search range of the line search.

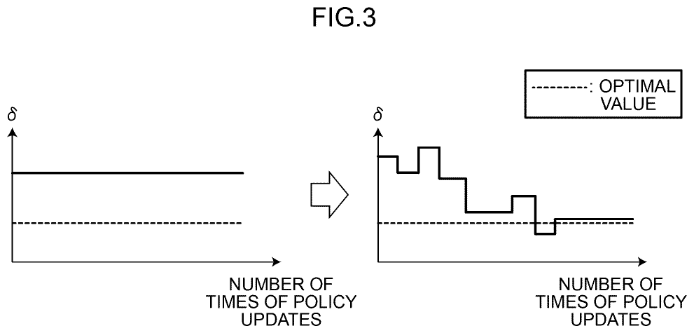

Here, adjustment of the upper limit value δ will be described with reference to FIG. 3. FIG. 3 is a diagram describing adjustment of δ according to the first embodiment. As illustrated in FIG. 3, the adjustment unit 12 adjusts the upper limit value δ every time the policy update is performed once by the training unit 11. That is, the adjustment unit 12 dynamically adjusts the upper limit value δ in parallel with training, and searches for an optimal value. Here, the left of FIG. 3 is a graph in a case where the policy is updated without change of the predetermined upper limit value δ. On the other hand, the right of FIG. 3 is a graph in a case where the upper limit value δ is dynamically adjusted on the basis of a result of performing the policy update once. In a case where the upper limit value δ is dynamically adjusted, the upper limit value δ is adjusted toward the optimal value as the number of times of policy update is increased.

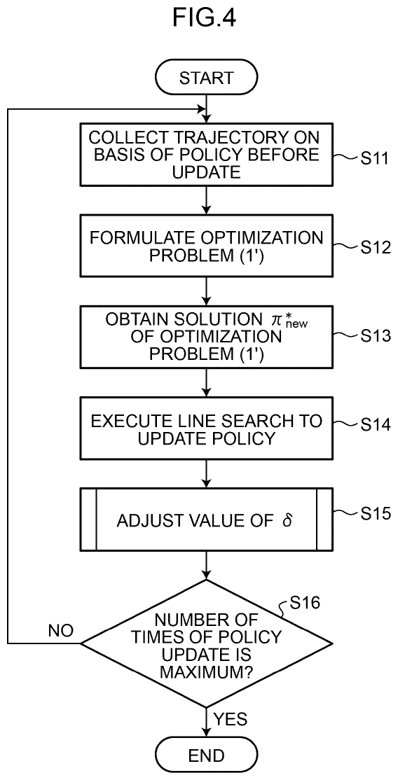

FIG. 4 is a diagram illustrating an example of a flowchart of reinforcement learning processing according to the first embodiment. Note that, in FIG. 4, it is assumed that the training unit 11 has received π_{old} as a policy before the update in the reinforcement learning.

Then, the training unit 11 collects Trajectory from the training data 21 on the basis of the policy before the update (step S11). Then, the training unit 11 formulates an optimization problem (1′) (step S12). For example, the training unit 11 formulates an optimization problem by using the collected Trajectory and Expression (1).

Then, the training unit 11 obtains a solution π⁺_{new} of the optimization problem (1′) (step S13). For example, the training unit 11 obtains an approximate solution π⁺_{new} having a maximum improvement range of the reward expected value in relation to π_{old} by using the left expression of Expression (1).

Then, the training unit 11 executes line search to update the policy (step S14). For example, the training unit 11 determines whether the constraint condition is satisfied that the difference between the approximate solution π⁺_{new} and the solution π_{old} before the update is less than or equal to the upper limit value δ. Then, in a case where the approximate solution π⁺_{new} does not satisfy the constraint condition of the optimization problem in relation to the solution π_{old} before the update, the training unit 11 brings the approximate solution π⁺_{new} closer to the solution π_{old} before the update and performs determination processing again. Then, if the approximate solution π⁺_{new} satisfies the constraint condition of the optimization problem in relation to the solution π_{old} before the update, the training unit 11 updates the policy to the approximate solution π⁺_{new}.

Subsequently, the adjustment unit 12 adjusts the value of δ indicating the upper limit value (step S15). Note that processing of adjusting the value of δ will be described later.

Then, the training unit 11 determines whether or not the number of times of policy update is a maximum (step S16). In a case where it is determined that the number of times of policy update is not the maximum (step S16; No), the training unit 11 proceeds to step S11 to perform processing in the next policy update.

On the other hand, in a case where it is determined that the number of times of policy update is the maximum (step S16; Yes), the training unit 11 ends the reinforcement learning processing.

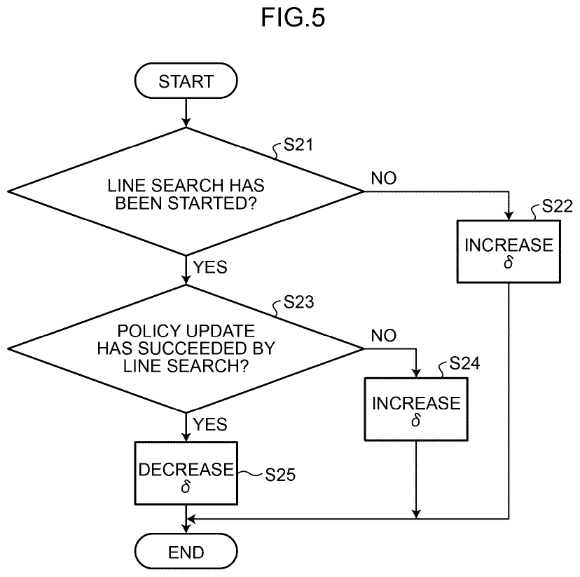

FIG. 5 is a diagram illustrating an example of a flowchart of adjustment processing according to the first embodiment. As illustrated in FIG. 5, the adjustment unit 12 determines whether or not the line search has been started for the policy update by the training unit 11 (step S21). That is, the adjustment unit 12 determines whether or not the line search has been started and the policy update has been performed.

In a case where it is determined that the line search has not been started (step S21; No), the adjustment unit 12 increases the upper limit value δ by a predetermined value (step S22). From the fact that the approximate solution π⁺_{new} can be updated without the line search, it can be said that the accuracy of approximation is sufficient, and thus, the upper limit value δ is increased for improvement of the training speed. Then, the adjustment unit 12 ends the adjustment processing.

On the other hand, in a case where it is determined that the line search has been started (step S21; Yes), the adjustment unit 12 determines whether or not the policy update has succeeded by the line search (step S23). In a case where it is determined that the policy update has not succeeded (failed) by the line search (step S23; No), the adjustment unit 12 increases the upper limit value δ by a predetermined value (step S24). As a result of repeating the line search, π⁺_{new} returns to π_{old} before the update, and no good policy has been found, and thus the upper limit value δ is increased to expand the search range of the line search. Then, the adjustment unit 12 ends the adjustment processing.

On the other hand, in a case where it is determined that the policy update has succeeded by the line search (step S23; Yes), the adjustment unit 12 decreases the upper limit value δ by a predetermined value (step S25). From the fact that the line search is started and the approximate solution π⁺_{new} is updated, it can be said that the accuracy of approximation is not sufficient, and thus, the upper limit value δ is decreased for improvement of the accuracy of approximation and accurate policy update. Then, the adjustment unit 12 ends the adjustment processing.

### Effects of First Embodiment

According to the first embodiment, in the policy optimization problem in the reinforcement learning, the information processing apparatus 1 observes the difference between the policies before and after the update when setting the trust region and performing the policy update for one time. The information processing apparatus 1 adjusts the threshold of the trust region according to an operation of an algorithm leading to policy update to cause the observed difference to remain within a certain range of the trust region. According to such a configuration, the information processing apparatus 1 can automatically adjust the threshold of the trust region optimal for the reinforcement learning.

Furthermore, according to the first embodiment, in the information processing apparatus 1, in processing of adjusting the threshold, it is determined whether the constraint condition is satisfied that the difference between the approximate solution of the policy and the policy before the update is less than or equal to the threshold. In the processing of adjusting the threshold, in a case where it is determined that the constraint condition is not satisfied, the approximate solution of the policy is brought closer to the policy before the update and the determination processing is repeated. In the processing of adjusting the threshold, in a case where it is determined that the constraint condition is satisfied, the approximate solution of the policy is updated. In the processing of adjusting the threshold, the threshold is adjusted on the basis of the operation of such an algorithm. According to such a configuration, the information processing apparatus 1 can adjust the threshold of the trust region by focusing on the operation of the algorithm that updates the policy.

Furthermore, according to the first embodiment, in the information processing apparatus 1, in the processing of adjusting the threshold, in a case where it is determined that the constraint condition is satisfied in the determination processing at the first time, the threshold is increased by the predetermined value. In the processing of adjusting the threshold, in a case where it is determined that the constraint condition is satisfied in the determination processing at the second and subsequent times even in a case where it is determined that the constraint condition is not satisfied in the determination processing at the first time, the threshold is decreased by the predetermined value. In the processing of adjusting the threshold, in a case where it is determined that the constraint condition is not satisfied in the determination processing at the second and subsequent times, the threshold is increased. According to such a configuration, the information processing apparatus 1 can adjust the optimal threshold of the trust region on the basis of the operation of the algorithm that updates the policy.

### (b) Second Embodiment

By the way, in the information processing apparatus 1 according to the first embodiment, it has been described that the adjustment unit 12 adjusts the upper limit value δ of the constraint condition by focusing on a line search operation (process) at the time of the policy update for one time. However, not limited to this, the adjustment unit 12 may adjust the upper limit value δ of the constraint condition by focusing on a difference (KL divergence) between the policy after the update obtained by the line search operation at the time of the policy update for one time and the policy before the update.

Thus, in a second embodiment, a description will be given of a case where the adjustment unit 12 in the information processing apparatus 1 adjusts the upper limit value δ of the constraint condition by focusing on the difference (KL divergence) between the policy after the update obtained by the line search operation at the time of the policy update for one time and the policy before the update. Note that a functional configuration of the information processing apparatus 1 according to the second embodiment is the same as that of the information processing apparatus 1 illustrated in FIG. 1, and thus the description thereof will be omitted.

The adjustment unit 12 according to the second embodiment adjusts the threshold of the trust region on the basis of the policy update for one time. For example, the adjustment unit 12 adjusts the upper limit value δ of the constraint condition by focusing on the difference (KL divergence) between the policy after the update obtained by the line search operation and the policy before the update.

As an example, the adjustment unit 12 calculates a difference between the policy after the update obtained by the line search operation and the policy before the update, which is a difference with respect to the upper limit value δ of the constraint condition used in the line search. That is, the adjustment unit 12 calculates E[D_{KL}(π⁺_{new}∥π_{old})]/δ.

Then, in a case where the calculated value is less than or equal to a first reference value, the adjustment unit 12 decreases the upper limit value δ by a predetermined value determined in advance. It is considered that an actual update range is smaller than the upper limit value δ and the update needs to be performed with a slightly smaller range in order to perform accurate policy update, so that the upper limit value δ is decreased. Note that the predetermined value only needs to be defined in advance according to the magnitude of the upper limit value δ, for example. In addition, the first reference value only needs to be defined in advance according to, for example, the magnitude of the upper limit value δ and the magnitude of the KL divergence.

Furthermore, in a case where the calculated value is greater than the first reference value, the adjustment unit 12 increases the upper limit value δ by a predetermined value determined in advance. It is considered that the actual update range is larger than the upper limit value δ and sufficiently accurate policy update can be performed with the current upper limit value δ, and thus, the upper limit value δ is increased for improvement of the training speed.

Here, a description will be given of a flowchart of the adjustment processing according to the second embodiment. Note that a flowchart of the reinforcement learning processing according to the second embodiment is the same processing as the flowchart of the reinforcement learning processing illustrated in FIG. 4, and thus the description thereof will be omitted.

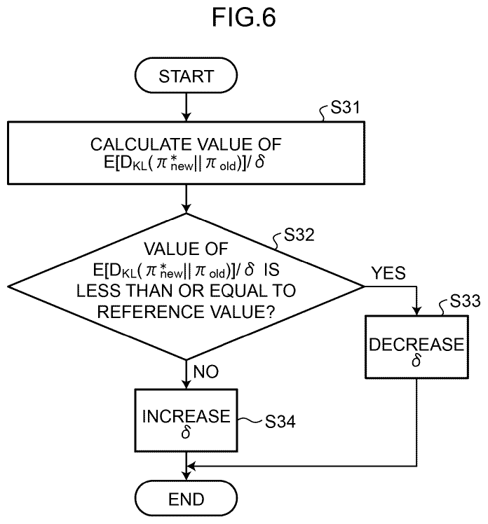

FIG. 6 is a diagram illustrating an example of the flowchart of the adjustment processing according to the second embodiment. Note that it is assumed that the adjustment processing by the adjustment unit 12 has received the policy π⁺_{new} after the update in the policy update for one time from the reinforcement learning processing by the training unit 11.

As illustrated in FIG. 6, the adjustment unit 12 calculates E[D_{KL}(π⁺_{new}∥π_{old})]/δ (step S31). Then, the adjustment unit 12 determines whether or not the calculated value is less than or equal to a reference value (step S32). In a case where it is determined that the calculated value is less than or equal to the reference value (step S32; Yes), the adjustment unit 12 decreases the upper limit value δ by a predetermined value (step S33). It is considered that an actual update range is smaller than the upper limit value δ and the update needs to be performed with a slightly smaller range in order to perform accurate policy update, so that the upper limit value δ is decreased. Then, the adjustment unit 12 ends the adjustment processing.

On the other hand, in a case where it is determined that the calculated value is not less than or equal to the reference value (step S32; No), the adjustment unit 12 increases the upper limit value δ by a predetermined value (step S34). It is considered that the actual update range is larger than the upper limit value δ and sufficiently accurate policy update can be performed with the current upper limit value δ, and thus, the upper limit value δ is increased for improvement of the training speed. Then, the adjustment unit 12 ends the adjustment processing.

### Effects of Second Embodiment

According to the second embodiment, in the information processing apparatus 1, in the processing of adjusting the threshold, when the trust region is set and the policy update for one time is performed in the policy optimization problem in the reinforcement learning, the difference between the policies before and after the update is observed. The information processing apparatus 1 adjusts the threshold on the basis of the difference between the policies before and after the update with respect to the threshold of the trust region, the difference being obtained by the operation of the algorithm leading to the policy update, to cause the observed difference to remain within a certain range of the trust region. According to such a configuration, the information processing apparatus 1 can automatically adjust the threshold of the trust region by using the difference between the policies before and after the update with respect to the threshold of the trust region.

Furthermore, according to the second embodiment, in the information processing apparatus 1, in the processing of adjusting the threshold, the threshold is increased by the predetermined value in a case where the difference between the policies before and after the update with respect to the threshold is greater than or equal to the first reference value, and the threshold is decreased by the predetermined value in a case where the difference between the policies before and after the update with respect to the threshold is less than the first reference value. According to such a configuration, the information processing apparatus 1 can adjust the optimal threshold of the trust region by using the difference between the policies before and after the update with respect to the threshold of the trust region.

### (c) Third Embodiment

By the way, in the information processing apparatus 1 according to the first embodiment, it has been described that the adjustment unit 12 adjusts the upper limit value δ of the constraint condition by focusing on an update operation in the line search at the time of the policy update for one time. However, not limited to this, the adjustment unit 12 may adjust the upper limit value δ of the constraint condition by focusing on the number of times of repetition in the line search at the time of the policy update for one time. The number of times of repetition in the line search herein refers to the number of times of repetition of the determination processing performed in the line search until the solution π⁺_{new} satisfies the constraint condition.

Thus, in a third embodiment, a description will be given of a case where the adjustment unit 12 in the information processing apparatus 1 adjusts the upper limit value δ of the constraint condition by focusing on the number of times of repetition in the line search up to the policy update for one time. Note that a functional configuration of the information processing apparatus 1 according to the third embodiment is the same as that of the information processing apparatus 1 illustrated in FIG. 1, and thus the description thereof will be omitted.

The adjustment unit 12 according to the third embodiment adjusts the threshold of the trust region on the basis of the policy update for one time. For example, the adjustment unit 12 adjusts the upper limit value δ of the constraint condition by focusing on the number of times of repetition in the line search up to the policy update for one time.

As an example, in a case where the number of times of repetition in the line search up to the policy update for one time is greater than or equal to a second reference value, the adjustment unit 12 decreases the upper limit value δ by a predetermined value determined in advance. It can be said that the accuracy of approximation is not sufficient, and thus, the upper limit value δ is decreased for improvement of the accuracy of approximation and accurate policy update. Note that the predetermined value only needs to be defined in advance according to the magnitude of the upper limit value δ, for example. In addition, the second reference value only needs to be defined in advance according to, for example, a value for bringing the solution π⁺_{new} closer to π_{old}, which is performed when the determination processing is repeated in the line search.

Furthermore, in a case where the number of times of repetition in the line search up to the policy update for one time is less than the second reference value, the adjustment unit 12 increases the upper limit value δ by a predetermined value set in advance. It can be said that the accuracy of approximation is sufficient, and thus, the upper limit value δ is increased for improvement of the training speed.

Here, a description will be given of a flowchart of the adjustment processing according to the third embodiment. Note that a flowchart of the reinforcement learning processing according to the third embodiment is the same processing as the flowchart of the reinforcement learning processing illustrated in FIG. 4, and thus the description thereof will be omitted.

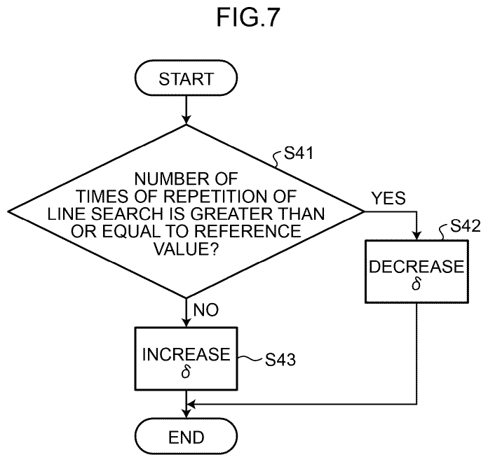

FIG. 7 is a diagram illustrating an example of the flowchart of the adjustment processing according to the third embodiment. Note that it is assumed that the adjustment processing by the adjustment unit 12 has received the number of times of repetition of the line search in the policy update for one time from the reinforcement learning processing by the training unit 11.

As illustrated in FIG. 7, the adjustment unit 12 determines whether or not the number of times of repetition of the line search is greater than or equal to the second reference value (step S41). In a case where it is determined that the number of times of repetition of the line search is greater than or equal to the second reference value (step S41; Yes), the adjustment unit 12 decreases the upper limit value δ by a predetermined value (step S42). It can be said that the accuracy of approximation is not sufficient, and thus, the upper limit value δ is decreased for improvement of the accuracy of approximation and accurate policy update. Then, the adjustment unit 12 ends the adjustment processing.

On the other hand, in a case where it is determined that the number of times of repetition of the line search is less than the second reference value (step S41; No), the adjustment unit 12 increases the upper limit value δ by a predetermined value (step S43). It can be said that the accuracy of approximation is sufficient, and thus, the upper limit value δ is increased for improvement of the training speed. Then, the adjustment unit 12 ends the adjustment processing.

### Effects of Third Embodiment

According to the third embodiment, in the information processing apparatus 1, in the processing of adjusting the threshold, the threshold is adjusted on the basis of the number of times of repetition leading to the update in the algorithm of: determining whether the constraint condition that the difference between the approximate solution of the policy and the policy before the update is less than or equal to the threshold is satisfied; bringing the approximate solution of the policy closer to the policy before the update and repeating the determination processing in a case where the constraint condition is determined not to be satisfied; and updating the approximate solution of the policy in a case where the constraint condition is determined to be satisfied. According to such a configuration, the information processing apparatus 1 can automatically adjust the threshold of the trust region by using the number of times of repetition of the algorithm leading to the policy update.

Furthermore, according to the third embodiment, in the information processing apparatus 1, in the processing of adjusting the threshold, the threshold is decreased by the predetermined value in a case where the number of times of repetition is greater than or equal to the second reference value, and the threshold is increased by the predetermined value in a case where the number of times of repetition is less than the second reference value. According to such a configuration, the information processing apparatus 1 can adjust the optimal threshold of the trust region by using the number of times of repetition of the algorithm leading to the policy update.

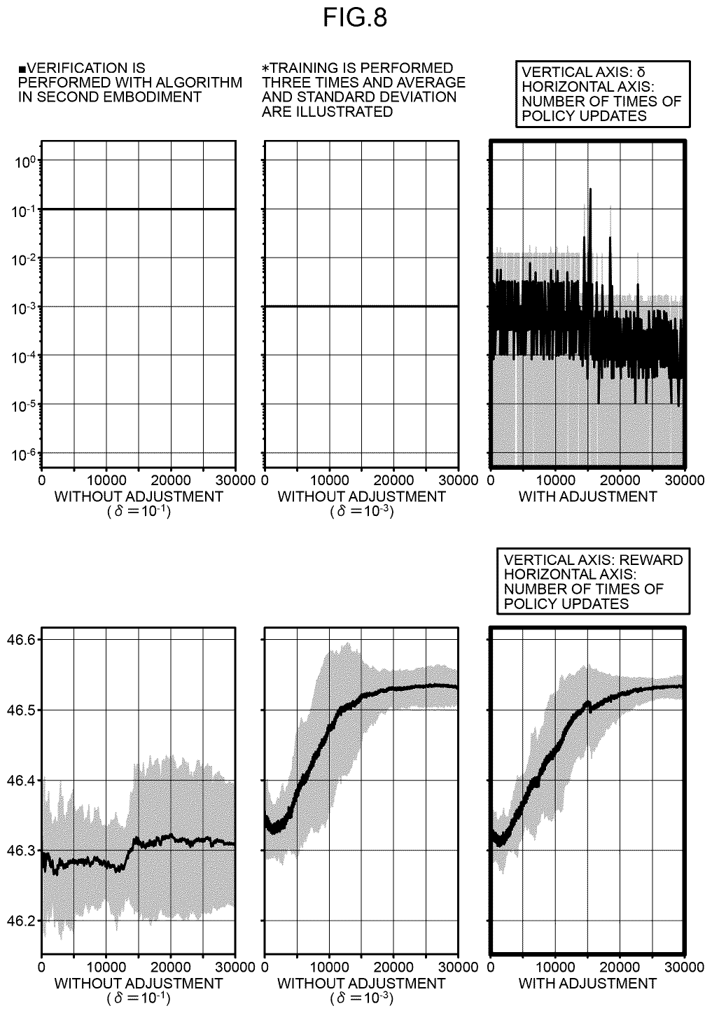

Here, an example of results of verification of the reinforcement learning processing according to the first to third embodiments will be described with reference to FIG. 8. FIG. 8 is a diagram illustrating the example of the results of verification of the reinforcement learning processing according to the first to third embodiments. Note that, in FIG. 8, the verification was performed with the reinforcement learning in a case where δ is a fixed value 10⁻¹ and a case where δ is a fixed value 10⁻³, as a case without adjustment of the upper limit value δ. Then, the verification was performed with the reinforcement learning in a case where the upper limit value δ was adjusted in the adjustment processing according to the second embodiment, as a case with adjustment of the upper limit value δ.

Under such situations, in the upper part of the drawing, there are graphs illustrating the upper limit value δ corresponding to the number of times of policy update in respective cases. That is, each graph represents the number of times of policy update on the horizontal axis and the upper limit value δ on the vertical axis. The left of the upper part of the drawing is a graph without adjustment in the case where the upper limit value δ is the fixed value 10⁻¹. Here, even when the number of times of policy update is increased, the upper limit value δ remains at 10⁻¹. The middle of the upper part of the drawing is a graph without adjustment in the case where the upper limit value δ is the fixed value 10⁻³. Here, even when the number of times of policy update is increased, the upper limit value δ remains at 10⁻³. On the other hand, the right of the upper part of the drawing is a graph with adjustment in which the upper limit value δ is adjusted. Here, the upper limit value δ varies. Then, the upper limit value δ decreases after convergence (after 20,000 times of policy update). Note that since training is performed three times in the same case, the graph includes three upper limit values for the same number of times of policy update.

In the lower part of the drawing, there are graphs illustrating a reward corresponding to the number of times of policy update in respective cases. That is, each graph represents the number of times of policy update on the horizontal axis and the reward on the vertical axis. Note that training is performed three times in the same case, and an average and a standard deviation are indicated in each graph. The black solid line is the average.

The left of the lower part of the drawing is a graph without adjustment in the case where the upper limit value δ is the fixed value 10⁻¹. The middle of the lower part of the drawing is a graph without adjustment in the case where the upper limit value δ is the fixed value 10⁻³. Here, it can be seen that the graph without adjustment in the case of the fixed value 10⁻³ has a higher reward as the number of times of policy update increases than the graph without adjustment in the case of the fixed value 10⁻¹. On the other hand, the right of the lower part of the drawing is a graph with adjustment in which the upper limit value δ is adjusted. Here, in the graph with adjustment, similarly to the graph without adjustment in the case of the fixed value 10⁻³, it can be seen that the reward increases as the number of times of policy update increases. That is, the information processing apparatus 1 can automatically adjust the upper limit value δ optimal for training by an adjustment mechanism for the upper limit value δ.

In addition, it can be seen that the graph with adjustment suppresses the variance for the training as compared with the graph without adjustment in the case of the fixed value 10⁻³. In particular, after the number of times of policy update is 20,000 steps or more, δ is decreased (see the right of the upper part of the drawing), and the variance for the training is suppressed. That is, the information processing apparatus 1 can suppress the variance for the training by adjusting the upper limit value δ. Furthermore, the information processing apparatus 1 can finely adjust δ by reducing a change range (predetermined value) of the upper limit value δ.

Note that a phenomenon occurs in which the reward decreases at the beginning of training, that is, at a time when the number of times of policy update is small. This is because the verification is performed by constrained reinforcement learning. This is because the constrained reinforcement learning has a characteristic of proceeding in a direction in which the constraint condition is satisfied even if the reward is lowered at the beginning of training.

### Others

Note that each of components of the information processing apparatus 1 illustrated in the drawing is not necessarily physically formed as illustrated in the drawing. That is, a specific form of the distribution and integration of the information processing apparatus 1 is not limited to the illustrated one, and all or a part thereof can be functionally or physically distributed and integrated in an arbitrary unit according to various loads, usage situations, and the like. Furthermore, the storage unit 20 may be connected via a network as an external device of the information processing apparatus 1.

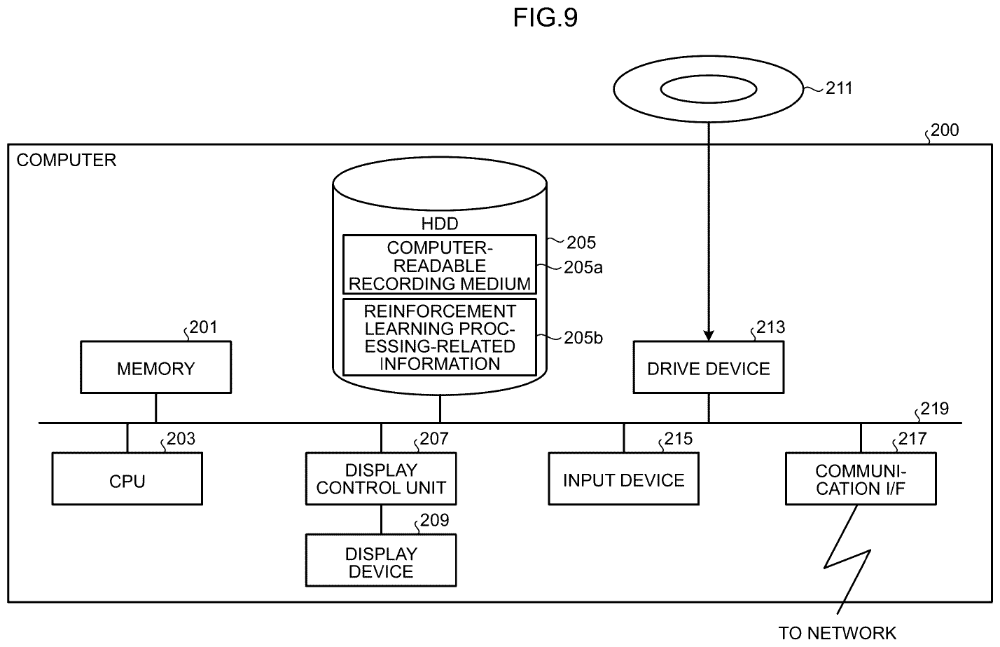

In addition, the various types of processing described in the above embodiments can be implemented by execution of a program prepared in advance on a computer such as a personal computer or a workstation. Thus, in the following, a description will be given of an example of a computer that executes a computer-readable recording medium that implements functions similar to those of the information processing apparatus 1 illustrated in FIG. 1. Here, the computer-readable recording medium that implements functions similar to those of the information processing apparatus 1 will be described as an example. FIG. 9 is a diagram illustrating the example of the computer that executes the computer-readable recording medium.

As illustrated in FIG. 9, a computer 200 includes a central processing unit (CPU) 203 that executes various types of arithmetic processing, an input device 215 that receives an input of data from a user, and a display device 209. Furthermore, the computer 200 includes a drive device 213 that reads a program and the like from a storage medium, and a communication interface (I/F) 217 that exchanges data with another computer via a network. Furthermore, the computer 200 includes a memory 201 that temporarily stores various types of information and a hard disk drive (HDD) 205. The memory 201, the CPU 203, the HDD 205, a display control unit 207, the display device 209, the drive device 213, the input device 215, and the communication I/F 217 are connected to each other by a bus 219.

The drive device 213 is, for example, a device for a removable disk 211. The HDD 205 stores a computer-readable recording medium 205a and reinforcement learning processing-related information 205b. The communication I/F 217 manages an interface between the network and the inside of the device, and controls input and output of data from another computer. For example, a modem, a LAN adapter, or the like can be adopted as the communication I/F 217.

The display device 209 is a display device that displays data such as a document, an image, and functional information, including a cursor, an icon, or a tool box. As the display device 209, for example, a liquid crystal display, an organic electroluminescence (EL) display, or the like can be adopted.

The CPU 203 reads the computer-readable recording medium 205a, deploys the medium in the memory 201, and executes the medium as a process. Such a process corresponds to each of functional units of the information processing apparatus 1. The reinforcement learning processing-related information 205b includes, for example, the training data 21. Then, for example, the removable disk 211 stores each piece of information such as the computer-readable recording medium 205a.

Note that the computer-readable recording medium 205a does not necessarily have to be stored in the HDD 205 from the beginning. For example, the medium may be stored in a “portable physical medium” such as a flexible disk (FD), a CD-ROM, a DVD disk, a magneto-optical disk, or an IC card inserted into the computer 200. Then, the computer 200 may read and execute the computer-readable recording medium 205a from these.

Furthermore, the reinforcement learning processing performed by the information processing apparatus 1 described in the first to third embodiments can be applied to, for example, sleep control of a mobile base station in order to save power of the mobile base station. The reinforcement learning processing can be applied to constrained policy optimization (CPO) that performs power saving while securing the communication quality of the mobile base station.

According to one embodiment, in the reinforcement learning in which the upper limit is set for the KL divergence, the value of the upper limit optimal for training can be automatically adjusted.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a program that causes a computer to execute processing comprising:
in a policy optimization problem in reinforcement learning,
observing a difference between policies before and after update when a trust region is set and policy update is performed; and
adjusting a threshold of the trust region according to an operation of an algorithm leading to policy update to cause the observed difference to remain within a certain range of the trust region.

2. The non-transitory computer-readable recording medium according to claim 1, wherein
in the processing of adjusting the threshold,
the threshold is adjusted on a basis of an operation of the algorithm of: determining whether a constraint condition that a difference between an approximate solution of the policy and a policy before update is less than or equal to the threshold is satisfied; changing the approximate solution of the policy closer to the policy before update and repeating determination processing in a case where the constraint condition is not satisfied; and updating the approximate solution of the policy in a case where the constraint condition is satisfied.

3. The non-transitory computer-readable recording medium according to claim 2, wherein
in the processing of adjusting the threshold, the threshold is increased in a case where the constraint condition is satisfied in the determination processing at a first time, the threshold is decreased by a predetermined value in a case where the constraint condition is satisfied in the determination processing at a second and subsequent times even in a case where the constraint condition is not satisfied in the determination processing at the first time, and the threshold is increased by a predetermined value when the constraint condition is not satisfied in the determination processing at the second and subsequent times.

4. The non-transitory computer-readable recording medium according to claim 1, wherein
in the processing of adjusting the threshold, the threshold is adjusted on a basis of a difference between policies before and after update with respect to the threshold, the difference being obtained by an operation of the algorithm.

5. The non-transitory computer-readable recording medium according to claim 4, wherein
in the processing of adjusting the threshold, the threshold is increased by a predetermined value in a case where the difference between policies before and after update with respect to the threshold is greater than or equal to a first reference value, and the threshold is decreased by a predetermined value in a case where the difference between policies before and after update with respect to the threshold is less than the first reference value.

6. The non-transitory computer-readable recording medium according to claim 1, wherein
in the processing of adjusting the threshold,
the threshold is adjusted on a basis of a number of times of repetition leading to update in the algorithm of: determining whether a constraint condition that a difference between an approximate solution of the policy and a policy before update is less than or equal to the threshold is satisfied; changing the approximate solution of the policy closer to the policy before update and repeating determination processing in a case where the constraint condition is not satisfied; and updating the approximate solution of the policy in a case where the constraint condition is satisfied.

7. The non-transitory computer-readable recording medium according to claim 6, wherein
in the processing of adjusting the threshold, the threshold is decreased by a predetermined value in a case where the number of times of repetition is greater than or equal to a second reference value, and the threshold is increased by a predetermined value in a case where the number of times of repetition is less than the second reference value.

8. An information processing apparatus comprising:
a memory and;
a processor coupled to the memory and configured to:
in a policy optimization problem in reinforcement learning,
observe a difference between policies before and after update when a trust region is set and policy update is performed; and
adjust a threshold of the trust region according to an operation of an algorithm leading to policy update to cause the observed difference to remain within a certain range of the trust region.

9. The information processing apparatus according to claim 8, wherein
the processor configured to adjust the threshold on a basis of an operation of the algorithm of: determining whether a constraint condition that a difference between an approximate solution of the policy and a policy before update is less than or equal to the threshold is satisfied; changing the approximate solution of the policy closer to the policy before update and repeating determination processing in a case where the constraint condition is not satisfied; and updating the approximate solution of the policy in a case where the constraint condition is satisfied.

10. The information processing apparatus according to claim 9, wherein
the processor configured to increase the threshold in a case where the constraint condition is satisfied in the determination processing at a first time, decrease the threshold by a predetermined value in a case where the constraint condition is satisfied in the determination processing at a second and subsequent times even in a case where the constraint condition is not satisfied in the determination processing at the first time, and increase the threshold by a predetermined value when the constraint condition is not satisfied in the determination processing at the second and subsequent times.

11. The information processing apparatus according to claim 8, wherein
the processor configured to adjust the threshold on a basis of a difference between policies before and after update with respect to the threshold, the difference being obtained by an operation of the algorithm.

12. The information processing apparatus according to claim 11, wherein
the processor configured to increase the threshold by a predetermined value in a case where the difference between policies before and after update with respect to the threshold is greater than or equal to a first reference value, and decrease the threshold by a predetermined value in a case where the difference between policies before and after update with respect to the threshold is less than the first reference value.

13. The information processing apparatus according to claim 8, wherein
the processor configured to adjust the threshold on a basis of a number of times of repetition leading to update in the algorithm of: determining whether a constraint condition that a difference between an approximate solution of the policy and a policy before update is less than or equal to the threshold is satisfied; changing the approximate solution of the policy closer to the policy before update and repeating determination processing in a case where the constraint condition is not satisfied; and updating the approximate solution of the policy in a case where the constraint condition is satisfied.

14. The information processing apparatus according to claim 13, wherein
the processor configured to decreases the threshold by a predetermined value in a case where the number of times of repetition is greater than or equal to a second reference value, and increases the threshold by a predetermined value in a case where the number of times of repetition is less than the second reference value.

15. A reinforcement learning method comprising:
in a policy optimization problem in reinforcement learning,
observing a difference between policies before and after update when a trust region is set and policy update is performed; and
adjusting a threshold of the trust region according to an operation of an algorithm leading to policy update to cause the observed difference to remain within a certain range of the trust region, by a processor.
